(19) United States
(12) Patent Application Publication
(10) Pub. No.: US 2014/0043020 A1
(43) Pub. Date: Feb. 13, 2014

(54) ROTATOR FOR AN ANGLE SENSOR

(71) Applicant: ASIAN KOGYO KABUSHIKI KAISHA, Obu-shi (KR)

(72) Inventors: Yasuhiro NISHIKAWA, Tokai-shi (JP); Shuji YAMAMOTO, Inazawa-shi (JP)

(73) Assignee: AISAN KOGYO KABUSHIKI KAISHA, Obu-shi (KR)

(21) Appl. No.: 13/952,477

(22) Filed: Jul. 26, 2013

(30) Foreign Application Priority Data
Aug. 8, 2012 (JP) 2012-176058

(51) Int. Cl. G01B 7/30

(52) U.S. Cl. CPC G01B 7/30
USPC 324/207.25

(57) ABSTRACT

A rotator for an angle sensor, includes a rotator body made from a resin material and having a boss portion that is formed in a hollow cylinder shape, a yoke formed in a ring shape and concentrically positioned in the boss portion, and a pair of magnets formed in an arc shape and located to face an inward facing surface of the yoke, wherein the magnets and the yoke are entirely located within the boss portion.

### CROSS-REFERENCE TO RELATED APPLICATION

The present application claims priority to Japanese patent application serial number 2012-176058, the contents of which are incorporated herein by reference.

### BACKGROUND

This disclosure relates to a rotator of an angle sensor for detecting the rotational angle of a rotor.

One example of an angle sensor is a throttle sensor (rotational angle detector) for detecting a rotational angle, i.e., opening ratio of a throttle valve in a throttle control device for an internal combustion engine. A throttle sensor typically has a magnetic property detection element installed on a throttle body, a throttle gear serving as a rotator and having a pair of magnets (permanent magnet) and a yoke that are configured as a magnetic circuit. It detects the rotational angle of the throttle gear as the opening ratio of the throttle valve without contacting with the throttle gear based on output signals from the magnetic property detection element. The throttle gear is a resin mold in which a pair of magnets and a yoke are positioned by insert molding. A gear body that is resin portion made from resin materials has a gear portion on its outer circumference and a hollow cylinder-shaped boss portion on its inner circumference. The yoke is shaped in a ring form and is positioned concentrically with the boss portion of the gear body. The magnets are shaped in an arc form, respectively, and are positioned to face an inner surface of the yoke. The sensor body is inserted into the boss portion without making contact with the boss portion. For example, such common throttle gear and throttle sensor are disclosed in Japanese Laid-Open Patent Publication No. 2004-332632.

In a common throttle gear, although a pair of magnets and a yoke are positioned within a boss portion of a gear body, inner facing surfaces of the magnets are exposed on an inner circumference of the boss portion of the gear body. Since the magnets are shaped in an arc form, each of them has a larger surface area than flat-shaped one. Thus, the pressure of the melted resin (referred to as resin pressure, hereafter) acts on a surface located within a resin mold (inner circumference and outer circumference (except area contacting with the yoke)) during insert molding, and no resin pressure acts on the inner circumference of the magnet. Accordingly, there is a large difference in stress between the surface located within in the resin and the surface not entirely located within the resin. Even if such a difference is significant, there is the possibility that the magnet may be cracked. Since cracking of magnet induces a change of magnetic property and affects detection of the opening ratio of the throttle, there has been the need for an improved angle sensor.

### SUMMARY

The One aspect of this disclosure is a rotator for an angle sensor, including a rotator body made from a resin material and having a boss portion that is formed in a hollow cylinder shape, a yoke formed in a ring shape and concentrically positioned in the boss portion, and a pair of magnets formed in an arc shape and located to face an inward facing surface of the yoke, wherein the magnets and the yoke are entirely located within the boss portion.

In accordance with this aspect, since the magnets and the yoke are entirely located within the boss portion, the resin pressure acts on a whole surface of the magnets except outer circumferences facing the yoke. Thus, it is able to decrease differences of pressures acting on the magnets and thus to prevent cracking of the magnets caused by such pressure differences.

### BRIEF DESCRIPTION OF THE DRAWINGS

For a detailed description of exemplary embodiments of the invention, reference will now be made to the accompanying drawings in which:

FIG. 1 is a cross-sectional view of a throttle control device for an internal combustion engine of one embodiment;

FIG. 2 is a plane view of a throttle gear;

FIG. 3 is a bottom view of the throttle gear;

FIG. 4 is a cross-sectional view along line IV-IV;

FIG. 5 is a cross-sectional view along line V-V;

FIG. 6 is a cross-sectional view along line VI-VI;

FIG. 7 is a cross-sectional view along line VII-VII;

FIG. 8 is a perspective view of an exploded throttle gear;

FIG. 9 is a cross-sectional view of a mold for a throttle gear corresponding to FIG. 4;

FIG. 10 is a cross-sectional view of the mold for the throttle gear corresponding to FIG. 5;

FIG. 11 is a cross-sectional view of the mold for the throttle gear corresponding to FIG. 6; and

FIG. 12 is a cross-sectional view of the mold for the throttle gear corresponding to FIG. 7.

### DETAILED DESCRIPTION

Each of the additional features and teachings disclosed above and below may be utilized separately or in conjunction with other features and teachings to provide improved rotators for angle sensors. Representative examples of the present invention, which examples utilized many of these additional features and teachings both separately and in conjunction with one another, will now be described in detail with reference to the attached drawings. This detailed description is merely intended to teach a person of skilled in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

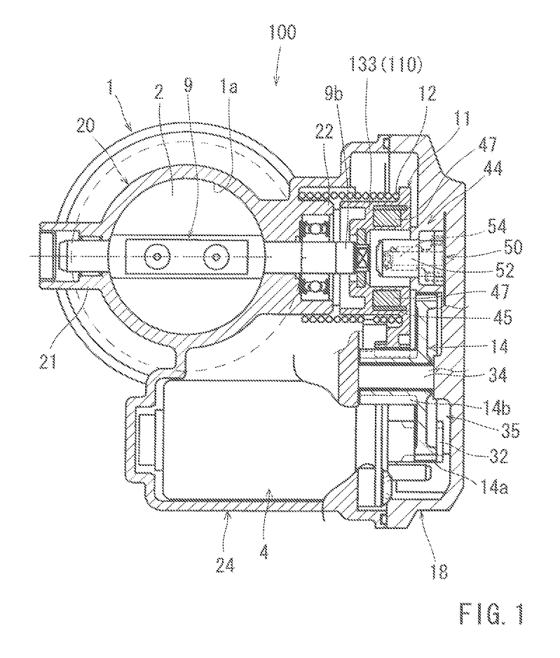

One embodiment will be described in reference with the drawings. In this embodiment, a throttle sensor used in a throttle control device for an internal combustion engine is exemplified as angle sensor. For convenience of explanation, the throttle control device for the internal combustion engine will be explained first. FIG. 1 is a cross-sectional view showing the throttle control device for the internal combustion engine. The basic configuration of a throttle control device 100 is substantially same with that of a throttle control device described in Japanese Laid-Open Patent Publication No. 2004-332632. Therefore, only an overview of such will be described herein.

As shown in FIG. 1, the throttle control device 100 has a throttle body 1. The throttle body 1 has a bore portion 20 and a motor housing 24 that are integrated with each other. In the bore portion 20, an intake pathway 1a extends in a direction perpendicular to the drawing of FIG. 1. Bearings 21 and 22 are provided at both sides of the bore portion 20 such that they rotatably support a throttle shaft 9 traversing the intake pathway 1a in a radial direction (horizontal direction in FIG. 1). The throttle shaft 9 has a butterfly-type throttle valve 2. Throttle valve 2 opens and closes the intake pathway 1a in accordance with the rotation of the throttle shaft 9 in order to control the amount of air flowing through the intake pathway 1a. Here, the throttle shaft 9 corresponds to “rotor” herein.

One end of the throttle shaft 9 that extends through the bearing 22 (at the right side in FIG. 1) is provided with a throttle gear 11 formed in a fan-shape. Between the throttle body 1 and the throttle gear 11, a back spring 12 is provided. The back spring 12 typically biases the throttle gear 11 such that it acts to close the throttle valve 2. Between the throttle gear 11 and a cover 18, a throttle sensor 44 (also, referred to as throttle open sensor, throttle position sensor, or the like) for detecting the throttle opening ratio of the throttle valve 2, i.e., rotational angel of the throttle shaft 9, is provided. The throttle gear 11 is typically a mold made from resin material and contains a pair of magnets 47 and a yoke 45 in a gear body 110. The throttle gear 11 will be described in detail later. The yoke 45 is composed of a magnetic circuit with the pair of the magnets 47 wherein the pair of the magnets 47 remain shielded. Here, the throttle gear 11 corresponds to “rotator” and “resin mold” herein. The throttle sensor 11 corresponds to “angle sensor” herein.

The motor housing 24 of the throttle body 1 houses a motor 4 therein. An output rotational shaft projecting in the right direction in FIG. 1 (an opposite direction of motor 4 insertion) is provided with a pinion gear (motor pinion) 32. A counter shaft 34, provided at a right side of the throttle body 1, rotatably supports a counter gear 14. The counter gear 14 has two gear portions 14a and 14b each having a differential gear ratio. The large-diameter gear portion 14a meshes with the pinion gear 32, and the small-diameter gear portion 14b meshes with the throttle gear 11. Thus, driving force of the motor 4 is transmitted through the pinion gear 32, the counter gear 14, the throttle gear 11 and to the throttle shaft 9. The throttle valve 2 is opened and closed by pivoting of the throttle shaft 9. Here, the pinion gear 32, the counter gear 14 and the throttle gear 11 create a reduction gear mechanism 35.

At a right side of the throttle body 1, the cover 18 covering the reduction gear mechanism 35 and the like is provided. At an inner surface of the cover 18, a sensor body 50 of the throttle sensor 44 is provided. The sensor body 50 is configured of a housing (holder) 52 and a sensor IC 54 housed therein. The sensor body 50 is inserted into a boss portion 113 (described later) of a gear body 110 of the throttle gear 11 in a non-contact condition. The sensor IC 54 is a magnetoelectric converting IC using a ferromagnetic magnetic resistance element that detects the strength of magnetic force caused by alteration of NS direction of the pair of magnets 47 of the throttle gear 11 and outputs electric signals depending on the strength of the magnetic force. The throttle sensor 44 detects the rotational angle of the throttle gear 11 as a throttle opening ratio dependent on signals output from the sensor IC 54 based on rotation of the throttle gear 11. An output side of the sensor IC 54 is connected to a control means (not shown) such as engine control unit (ECU) for automobile. The sensor body 50 can be composed of a magnetic detection element such as a hole element, a hole IC, magnetic resistance element, in addition to the sensor (magnetoelectric converting) IC 54. Here, the cover 18 corresponds to stator, and throttle body member, herein. And, the sensor IC 54 corresponds to magnetic property detection element.

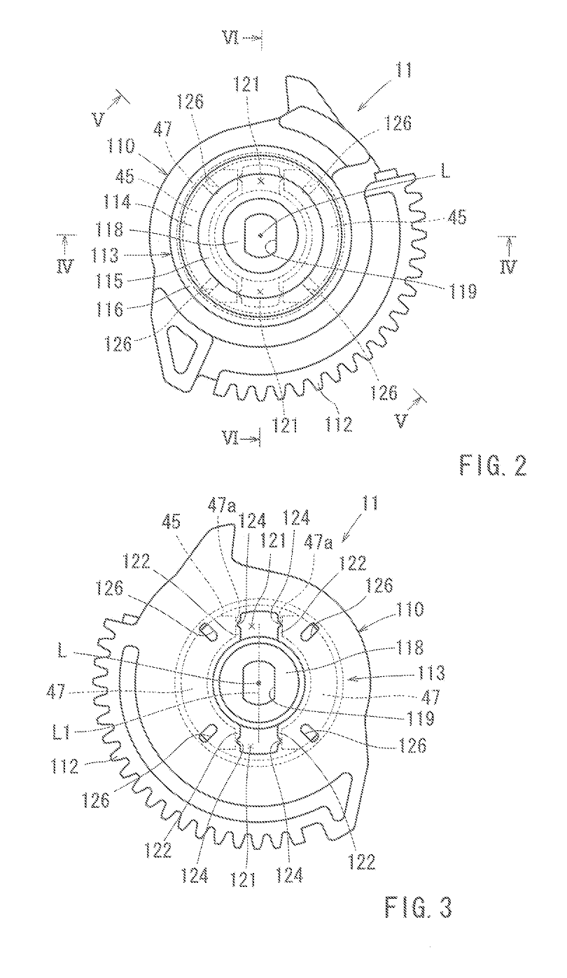

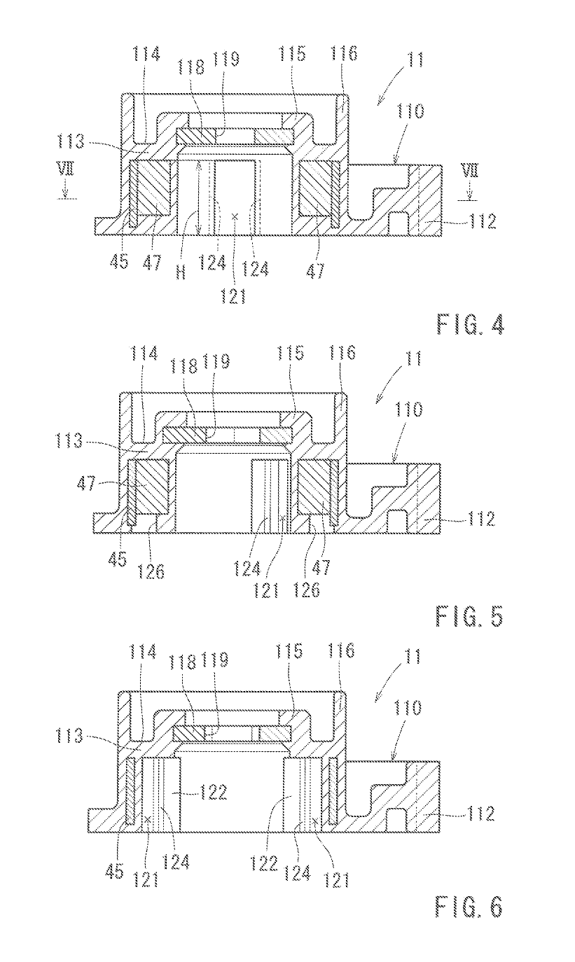

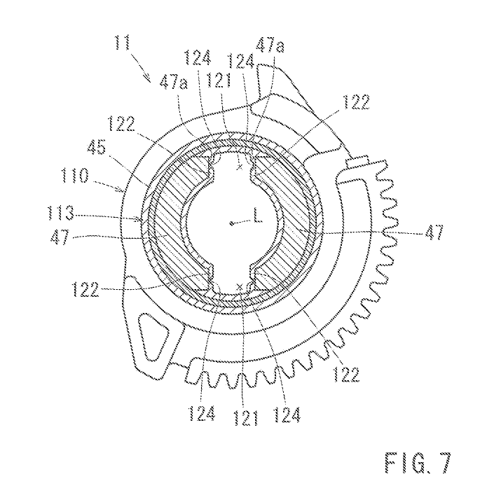

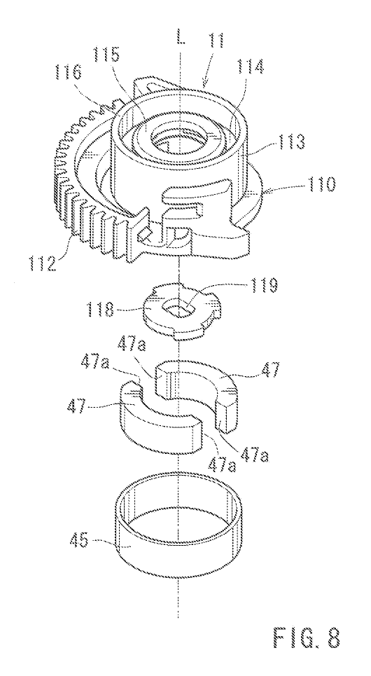

Next, the throttle gear 11 will be described. FIG. 2 is a plane view of the throttle gear 11, FIG. 3 is a bottom view thereof. FIG. 4 is a cross-sectional view along IV-IV line in FIG. 2. FIG. 5 is a cross-sectional view along V-V line in FIG. 2. FIG. 6 is a cross-sectional view along VI-VI line in FIG. 2. FIG. 7 is a cross-sectional view along VII-VII line in FIG. 4. FIG. 8 is an exploded perspective view of the throttle gear. Here, in the drawings, for the convenience of explanation, a side near the throttle body 1 is going to be the upper side (left side in FIG. 1), whereas another side near the cover 18 is going to be the lower side (right side in FIG. 2).

As shown in FIG. 2, the throttle gear 11 has a gear body 110 as a resin portion made from resin materials. The gear body 110 has a fan-shaped gear portion 112 at its outer periphery and a hollow cylinder-shaped boss portion 113 at its inner periphery. The gear portion 112 and the boss portion 113 are concentrically located. The gear portion 112 protrudes from a lower portion of the boss portion 113 toward the outside (see FIGS. 4-6 and 8). As shown in FIG. 4, on the upper surface of the boss portion 113, a circular groove 114 is concentrically formed. Thus, at the upper end of the boss portion 113, an inner cylinder 115 and an outer cylinder 116 are concentrically formed. The outer cylinder 116 extends upward such that an upper end of the outer cylinder 116 is above the inner cylinder 115. Here, the gear body 110 corresponds to rotator body.

Inside the inner cylinder 115 of the boss portion 113, a metallic mounting plate 118 that is formed in a circular plate shape is concentrically provided. That is, an outer periphery of the mounting plate 118 is formed in a concave-convex shape (see FIG. 8), and the outer periphery is entirely located within the inner cylinder 115 of the boss portion 113, i.e., resin portion such that the mounting plate 118 is integrated in non-rotatable state. At a center of the mounting plate 118, an oval shaped mounting hole 119 is formed. The mounting plate 118 is integrated with the throttle shaft 9 by engaging a right end of the throttle shaft 9 (see FIG. 1) with the mounting hole 119 in non-rotatable state and then swaging the end.

As shown in FIG. 4, insert molding is used to position the pair of magnets 47 and the yoke 45 in a lower inside of the boss portion 113 (see FIG. 7). As shown in FIG. 8, the yoke 45 is made from magnetic material in a hollow cylinder shape. The magnets 47 are formed in an arc shape along an inner surface of the yoke 45. The pair of magnets 47 are formed in the same shape. As shown in FIG. 7, at an inner facing surface of the yoke 45, the pair of magnets 47 are located in a manner facing each other, i.e., the magnets 47 symmetrically face each other with respect to an axis L of the throttle gear 11. There are predetermined gaps between end surfaces 47a of the magnets 47 in a circumferential direction (see FIG. 8). The pair of magnets 47 and the yoke 45 are preferably entirely located within the boss portion 113, i.e., resin portion (see FIGS. 2-7).

As shown in FIG. 3, a pair of spaces 121 are provided in the boss portion 113 of the gear body 110 such that the spaces 121 are positioned in a symmetrical manner about the axis L of the throttle gear 11. The spaces 121 are formed in a concave shape with respect to the bottom surface of the boss portion 113 between the circumferential end surfaces 47a of the magnets 47. The spaces 121 open at the bottom surface and inner circumferential surface of the boss portion 113 (see FIGS. 6 and 7). As shown in FIG. 7, thin walls 122 made from resin materials are provided between the spaces 121 and the circumferential end surfaces 47a of the magnets 47. As shown in FIG. 4, a height H of the spaces 121 with respect to axial direction of the boss portion 113 is same or substantially same with height between the bottom surface of the boss portion 113 and upper surfaces of magnets 47.

As shown in FIG. 3, straight grooves 124 extending in the axial direction of the boss portion 113 (vertical direction) are formed at both side walls of the spaces 121 with respect to circumferential direction of the boss portion 113 (see FIG. 7). Each of the grooves 124 corresponds to a radial center of the circumferential end surface 47a of the nearest magnet 47. Each of the grooves 124 is formed in a triangular cross-section and is tapered toward the circumferential end surface 47a of the magnet 47. The groove 124 has an end contacting or positioned in close proximity to the circumferential end surface 47a of the magnet 47. Here, the groove 124 corresponds to “concave portion” herein.

As shown in FIG. 3, at one end surface in the axial direction, i.e., a bottom surface of the boss portion 113, two vertical holes 126 per magnet, that is, a total of four are located in a symmetric manner about the axis L. As shown in FIG. 5, the vertical holes 126 extend upward from the bottom surface of the boss portion 113 along axial direction of the boss portion 113 in a straight manner, and their upper ends reach the lower surfaces of the yoke 45 and the magnets 47. The vertical holes 126 are formed in elongated shapes extending in a radial direction of the boss portion 113 as seen from a bottom view (see FIG. 3). Thus, an inner portion of the lower surface of the yoke 45 and outer portions of lower surfaces of the magnets 47 are partially exposed via the vertical holes 126. Two of the vertical holes 126 corresponding to magnet 47 are positioned in symmetric manner about the line L1 that is perpendicular to the axis L of the throttle gear 11 and extends through a circumferential center of the spaces 121. Here, the vertical holes correspond to “axial directional holes” herein.

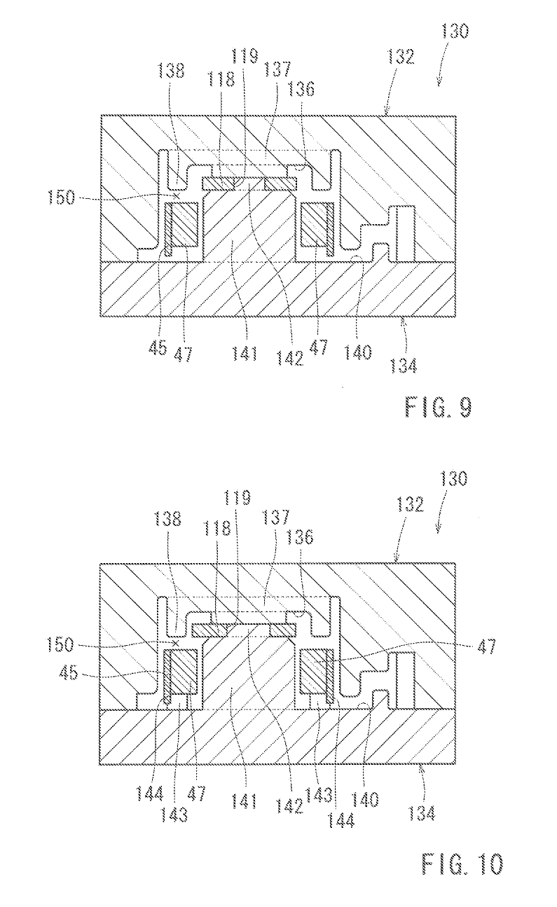

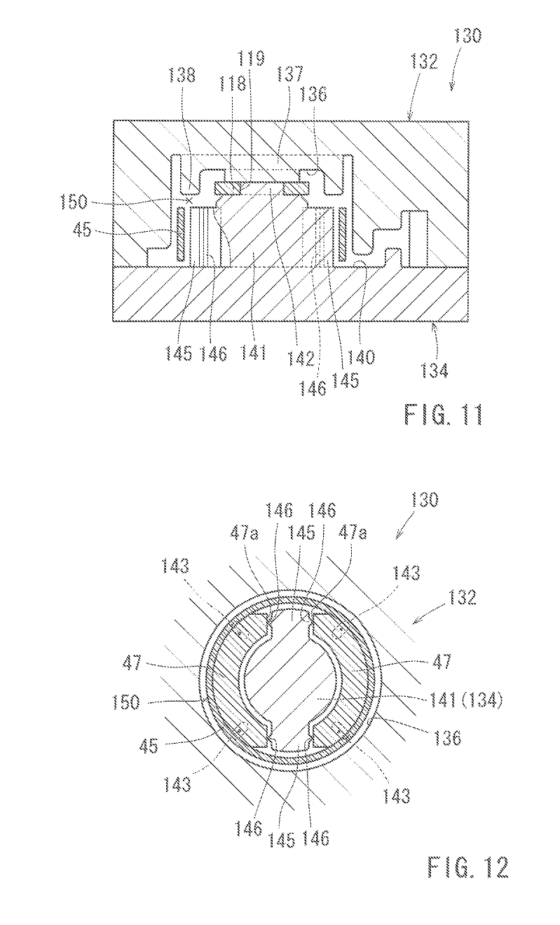

Next, a mold for shaping the throttle gear 11 will be described. FIG. 9 is a cross-sectional view showing a mold of the throttle gear corresponding to FIG. 4. FIG. 10 is a cross-sectional view corresponding to FIG. 5. FIG. 11 is a cross-sectional view corresponding to FIG. 6. FIG. 12 is a partial cross-sectional view corresponding to FIG. 7. As shown in FIGS. 9-12, a forming mold 130 has an upper mold 132 as a fixed mold and a lower mold 134 as a movable mold that can open and close the upper mold 132.

As shown in FIG. 9, a shaping surface 136 that has a shape corresponding to an upper surface of the throttle gear 11 (see FIGS. 2-7) is formed at a lower surface of the upper mold 132. At the shaping surface 136, a middle mold 137 corresponding to an inner surface of an end of the upper surface of the boss portion 113 of the gear body 110 of the throttle gear 11 (see FIGS. 4-7) is provided. A lower surface of a center portion of the middle mold 137 faces the upper surface of the mounting plate 118 and an end surface (upper surface) of a projection 142 of a middle mold 141 (described below) of the lower mold 134. The shaping surface 136 has a circular projection 138 for shaping the circular groove 114 of the gear body 110 (see FIG. 4).

A shaping surface 140 corresponding to the lower surface of the throttle gear 11 (FIGS. 2-7) is formed on the upper surface of the lower mold 134. At the shaping surface 140, a middle mold 141 formed in a cylinder shape corresponding to the inner circumferential surface of the boss portion 113 of the gear body 110 is provided. An upper end surface of the middle mold 141 faces a lower surface of the mounting plate 118. And, the projection 142 is formed at an upper end surface of the middle mold 141. The projection 142 typically engages the mounting hole 119 of the mounting plate 118.

As shown in FIG. 10, on the shaping surface 140 of the lower mold 134, four (two of them are shown in FIG. 10) band-shaped support portions 143 are positioned around the middle mold 141 (FIG. 12). At an outer circumference of an upper end of the support portions 143, an L-shaped groove 144 is provided such that its outer end is low (see FIG. 10). And, the support portions 143 are molds each corresponding to the vertical hole 126 of the gear body 110 (see FIGS. 3 and 5).

As shown in FIG. 12, a pair of square-formed shaping projections 145 is provided at an outer circumference of the middle mold 141 of the lower mold 134. Each of the shaping projections 145 has a lower end surface continuing with the shaping surface 140 (see FIG. 11). The shaping projections 145 are molds corresponding to the spaces 121 of the gear body 110 (see FIGS. 6 and 7). As shown in FIG. 12, straight projections 146 extending in the axial direction of the middle mold 141 (vertical direction) are provided on both sides of the shaping projection 145 in the circumferential direction of the middle mold 141 (see FIG. 11). The straight projections 146 are molds corresponding to the grooves 124 of the gear body 110 (see FIG. 7).

Next, a producing method for shaping the throttle gear 11 by using the mold 130 will be described. When the mold is opened, the lower end of the yoke 45 is engaged with the grooves 144 (see FIG. 10) of four support portions 143 (see FIG. 12) of the lower mold 134. At this time, the lower end of the yoke 45 contacts with lower surfaces of the grooves 144 of the support portions 143. With this, an inner circumferential surface of the lower end of the yoke 45 contacts with side surfaces of the grooves 144. Thus, the yoke 45 is supported on the four support portions 143 to be positioned in the radial direction.

The pair of magnets 47 are disposed along an inner surface of the yoke 45 (FIG. 12). When the magnets 47 are engaged between the shaping projections 145 of the lower mold 134, the circumferential end surfaces 47a contact or come close to top edges of the straight projections 146 of the shaping projections 145. Thus, the pair of magnets 47 are positioned in the circumferential direction. With this, upper surfaces of the four support portions 143 contact with lower surfaces of the magnets 47, so that the magnets 47 are supported on the four support portions 143 (see FIG. 10). Under this condition, an upper surface of the yoke 45 is on the substantially same level with upper surfaces of the magnets 47. The mounting plate 118 is placed on an upper surface of the middle mold 141 of the lower mold 134 (FIG. 9). The mounting hole 119 of the mounting plate 118 is engaged with the projection 142. As a result, the mounting plate 118 is supported on the middle mold 141 in a fixed state in a circumferential direction.

And then, the upper mold 132 is closed with the lower mold 134 (see FIGS. 9-12). Thus, a cavity for shaping the throttle gear 11 (FIGS. 2-7) is created between the upper mold 132 and the lower mold 134. And, the mounting plate 118 is held between the middle mold 137 of the upper mold 132 and the middle mold 141 of the lower mold 134 (FIG. 9). By injecting melted resin into the cavity from an injection gate (not shown) of the upper mold 132 with a predetermined injection pressure, the throttle gear 11 is molded. During this, the pair of magnets 47, the yoke 45 and the mounting plate 118 are entirely located within the melted resin by insert molding. The pair of magnets 47, the yoke 45 and the mounting plate 118 are integrated with the gear body 110 by such insert molding. The melted resin flows in the cavity 150 such that the pair of magnets 47 and the yoke 45 are entirely located within the resin portion.

In a result of the insert molding, the pair of magnets 47, the yoke 45 and the mounting plate 118 (in detail, outer periphery thereof) are entirely located within the melted resin that forms the gear body 110 and are positioned by the resin. After hardening of the melted resin, the throttle gear 11 (FIGS. 2-7) is obtained by opening the molds. The throttle gear 11 contains the pair of magnets 47, the yoke 45 and the mounting plate 118 that are integrated with the gear body 110 as the resin portion. The pair of spaces 121 (FIG. 3) each having grooves 124 on the lower surface of the gear body 110 are shaped by removing the shaping projections 145 (see FIGS. 11 and 12) each having the straight projections 146 of the lower mold 134. The four vertical holes 126 (see FIGS. 3 and 5) on the lower surface of the gear body 110 are shaped by removing the support portions 143 of the lower mold 134 (FIG. 5).

With respect to the throttle gear 11 (see FIGS. 2-7), the pair of magnets 47 and the yoke 45 are entirely located within the boss portion 113 of the gear body 110, so that pressure of the melted resin acts on a whole surface of the magnets 47 except for the outer periphery facing the yoke 45. Accordingly, a difference between pressures acting on the magnets 47 can be decreased, so that it is able to prevent breakage of the magnets 47.

At the boss portion 113 of the gear body 110, the spaces 121 that are close to the circumferential end surfaces 47a of the magnets 47 via the thin walls 122 are formed. Thus, the spaces 121 formed at the boss portion 113 of the gear body 110 can decrease pressure generated during shrinkage of the boss portion 113 when a heating-cooling cycle is in use. As a result, it is able to prevent cracking of the boss portion 113, that is, resin cracking.

The grooves 124 communicated with the spaces 121 and tapered toward the end surfaces of the magnets 47 are formed at the thin walls 122 (FIG. 7). Accordingly, it is able to prevent burr production between the circumferential end surfaces 47a of the magnets 47 and the grooves 124 of the thin walls 122. In detail, at small spaces between the circumferential end surfaces 47a of the magnets 47 and ends of the grooves, resin burr having an area in accordance with such spaces are produced. Accordingly, the grooves 124 are shaped to be tapered toward the end surfaces of the magnets 47, so that such area created in accordance with the small spaces between the circumferential end surfaces 47a of the magnets 47 and the ends of the grooves 124 can be decreased compared with, e.g., in a case the grooves have square cross-section, thereby decreasing the production of resin burrs.

At the axial end surface of the boss portion 113 of the gear body 110, there are four vertical holes 126 extending in the axial direction and reaching end surfaces of the magnets 47 and the yoke 45 (see FIGS. 3 and 5). Thus, parts of the mold corresponding to the four vertical holes 126 are set as four support portions 143 on the lower mold 134 of the forming mold 130 of the throttle gear 11, and the pair of magnets 47 and the yoke 45 can be supported by the four support portions 143.

Parts of the mold corresponding to the spaces 121 (see FIGS. 3 and 7) of the boss portion 113 of the gear body 110 are set as the shaping projections 145 (see FIGS. 11 and 12) on the lower mold 134 of the forming mold 130, and the shaping projections 145 can form the spaces 121. Parts of the mold corresponding to the grooves 124 (see FIGS. 3 and 7) of the thin walls 122 are set as straight projections 146 (see FIGS. 11 and 12) on the shaping projections 145 of the lower mold 134 of the forming mold 130, and the straight projections 146 can shape the grooves 124. The circumferential end surfaces 47a of the magnets 47 facing the straight projections 136 contact with or come close to the straight projections 136, so that the pair of magnets 47 can be positioned in the circumferential direction (FIG. 12).

The present invention is not limited to the above embodiments and can be modified without departing from the scope of the invention. For example, a rotator of an angle sensor of the present invention is not limited to the throttle gear 11 of the throttle sensor 44 and can be used for rotators of various angle sensors. For example, in a flow control valve for controlling flow rate of fluid, it can be applied to a rotator for an angle sensor for detecting the rotation angle of a valve body. The spaces 121 of the gear body 110 are provided between the circumferential end surfaces 47a of the magnets 47 but can be provided at each circumferential end surface 47a of the magnets 47. Cross-section of the grooves 124 of the spaces 121 of the gear body 110 is not limited to a triangular shape but rather can be shaped as semicircular, trapezoidal, or square. The grooves 124 of the spaces 121 of the gear body 110 can be omitted. Three or more vertical holes 126 of the gear body 110 can be provided at each of the magnets 47. The yoke 45 can be formed in a C-shape or can be shaped in a circle shape with two half-round shaped parts. Although the upper mold 132 is set as fixed mold and the lower mold 134 is set as movable mold in the embodiment, the upper mold 132 can be set as movable mold and the lower mold 134 can be set as fixed mold.

What is claimed is:

1. A rotator for an angle sensor, comprising
a rotator body made from a resin material and having a boss portion that is formed in a hollow cylinder shape;
a yoke formed in a ring shape and concentrically positioned in the boss portion; and
a pair of magnets formed in an arc shape and located to face an inward facing surface of the yoke;

2. The rotator according to claim 1, wherein circumferential ends of the magnets each has a thin wall, and the boss portion defines a space close to the circumferential ends of the magnets via the thin walls.

3. The rotator according to claim 2, wherein each of the thin walls has a concave portion tapered toward the corresponding circumferential end of the magnet.

4. The rotator according to claim 1, wherein the boss portion has a vertical hole at one end surface such that the vertical hole extends in an axial direction and reaches to the end of the yoke and the ends of the magnets.
